(19) United States
(12) Patent Application Publication
(10) Pub. No.: US 2016/0216586 A1
(43) Pub. Date: Jul. 28, 2016

(54) LIQUID CRYSTAL DISPLAY AND MANUFACTURING METHOD THEREOF

(71) Applicant: Samsung Display Co., Ltd., Yongin-si (KR)

(72) Inventors: Young Joo CHOI, Suwon-si (KR); Chang Ha KWAK, Hwaseong-si (KR); Hee Jung YOON, Incheon (KR); Jin Yool KIM, Asan-si (KR); Jae Phil LEE, Seongnam-si (KR)

(21) Appl. No.: 14/956,472

(22) Filed: Dec. 2, 2015

(30) Foreign Application Priority Data
Jan. 22, 2015 (KR) 10-2015-0010709

(51) Int. Cl. G02F 1/1362; G02F 1/1333; G02F 1/1343

(52) U.S. Cl. CPC G02F 1/136286; G02F 1/13439; G02F 1/133345; G02F 1/136227; G02F 2001/136295; G02F 2001/136218

(57) ABSTRACT

A liquid crystal display and a manufacturing method thereof include a planar-shaped common electrode disposed directly on a common voltage line, and a semiconductor layer disposed on the common electrode and a gate line, serving as a gate insulating layer. Accordingly, it is possible to prevent signal delay of the common voltage and lower the manufacturing cost by disposing a common electrode and a pixel electrode on one substrate and disposing a common electrode directly on a common voltage line.

### CROSS-REFERENCE TO RELATED APPLICATION

This application claims priority from and the benefit of Korean Patent Application No. 10-2015-0010709, filed on Jan. 22, 2015, which is hereby incorporated by reference for all purposes as if fully set forth herein.

### BACKGROUND

1. Field

Exemplary embodiments relate to a liquid crystal display and a manufacturing method thereof

2. Discussion of the Background

A liquid crystal display, which is one of the most common types of flat panel displays currently in use, is a display device that applies voltages to electrodes to thereby is rearrange liquid crystal molecules of a liquid crystal layer so that an amount of light transmitted may be adjusted.

The liquid crystal display has the advantage of making it easy to reduce a thickness, but has a drawback in that side visibility is typically lower than front visibility. In order to overcome this drawback, various types of liquid crystal arrangements and driving methods are being developed. As a means for implementing a wide viewing angle, a liquid crystal display, in which a pixel electrode and a common electrode are formed on a single substrate, has attracted attention. In the case of this type of liquid crystal display, a common voltage line for transferring a common voltage is formed in order to prevent signal delay of the common voltage applied to a common electrode.

As such, different types of photomasks are required to form a common voltage line, a pixel electrode, and a common electrode on one substrate, thereby increasing a manufacturing cost.

The above information disclosed in this Background section is only for enhancement of understanding of the background of the inventive concept, and, therefore, it may contain information that does not form the prior art that is already known in this country to a person of ordinary skill in the art.

### SUMMARY

Exemplary embodiments provide a liquid crystal display and a manufacturing method thereof, having advantages of being capable of preventing signal delay of a common voltage and an increase in a manufacturing cost while forming two field generating electrodes on one substrate.

Additional aspects will be set forth in the detailed description which follows, and, in part, will be apparent from the disclosure, or may be learned by practice of the inventive concept.

An exemplary embodiment discloses a liquid crystal display including: a substrate; a gate line, and a common voltage line disposed on the substrate; a common electrode disposed directly on the common voltage line; a semiconductor layer disposed on the gate line and the common electrode; and a pixel electrode disposed on the semiconductor layer. The common electrode and the pixel electrode are overlapped with each other, with the semiconductor layer disposed therebetween.

The semiconductor layer may be formed on an entire surface of the substrate.

The liquid crystal display may further include a data line, a source electrode, and a drain electrode formed on the semiconductor layer, and a passivation layer formed on the source electrode and the drain electrode.

The passivation layer may include a contact hole for partially exposing the drain electrode and a cutout for partially exposing the data line, and the pixel electrode may be connected to the drain electrode through the contact hole.

The liquid crystal display may further include a shielding electrode configured to cover top and side surfaces of a part of the data line that is exposed through the cutout.

An exemplary embodiment also discloses a manufacturing method of a liquid crystal display, including: forming a gate line and a common voltage line on a substrate; forming a common electrode directly on the common voltage line; forming a semiconductor layer on the gate line and the common electrode; and forming a pixel electrode on the semiconductor layer. The common electrode and the pixel electrode overlap each other, with the semiconductor layer disposed therebetween.

The foregoing general description and the following detailed description are exemplary and explanatory and are intended to provide further explanation of the claimed subject matter.

### BRIEF DESCRIPTION OF THE DRAWINGS

The accompanying drawings, which are included to provide a further understanding of the inventive concept, and are incorporated in and constitute a part of this specification, illustrate exemplary embodiments of the inventive concept, and, together with the description, serve to explain principles of the inventive concept.

FIG. 1 is a layout view of a liquid crystal display according to an exemplary embodiment.

FIG. 2 is a cross-sectional view of the liquid crystal display shown in FIG. 1 taken along the line II-II.

FIG. 3 is a cross-sectional view of the liquid crystal display shown in FIG. 1 taken along the line III-III.

FIG. 4, FIG. 7, FIG. 10, and FIG. 13 are layout views sequentially illustrating a manufacturing method of a liquid crystal display according to an exemplary embodiment.

FIG. 5, FIG. 8, FIG. 11, and FIG. 14 are cross-sectional views sequentially illustrating a manufacturing method of a liquid crystal display according to an exemplary embodiment, which are taken along the line II-II of FIG. 1.

FIG. 6, FIG. 9, FIG. 12, and FIG. 15 are cross-sectional views sequentially illustrating a manufacturing method of a liquid crystal display according to an exemplary embodiment, which are taken along the line III-III of FIG. 1.

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

In the accompanying figures, the size and relative sizes of layers, films, panels, regions, etc., may be exaggerated for clarity and descriptive purposes. Also, like reference numerals denote like elements.

When an element or layer is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

Although the terms first, second, etc. may be used herein to describe various elements, components, regions, layers, and/or sections, these elements, components, regions, layers, and/or sections should not be limited by these terms. These terms are used to distinguish one element, component, region, layer, and/or section from another element, component, region, layer, and/or section. Thus, a first element, component, region, layer, and/or section discussed below could be termed a second element, component, region, layer, and/or section without departing from the teachings of the present disclosure.

Spatially relative terms, such as “beneath,” “below,” “lower,” “above,” “upper,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one is or more other features, integers, steps, operations, elements, components, and/or groups thereof

Various exemplary embodiments are described herein with reference to sectional illustrations that are schematic illustrations of idealized exemplary embodiments and/or intermediate structures. As such, variations from the shapes of the illustrations as a result, for example, of manufacturing techniques and/or tolerances, are to be expected. Thus, exemplary embodiments disclosed herein should not be construed as limited to the particular illustrated shapes of regions, but are to include deviations in shapes that result from, for instance, manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the drawings are schematic in nature and their shapes are not intended to illustrate the actual shape of a region s of a device and are not intended to be limiting.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

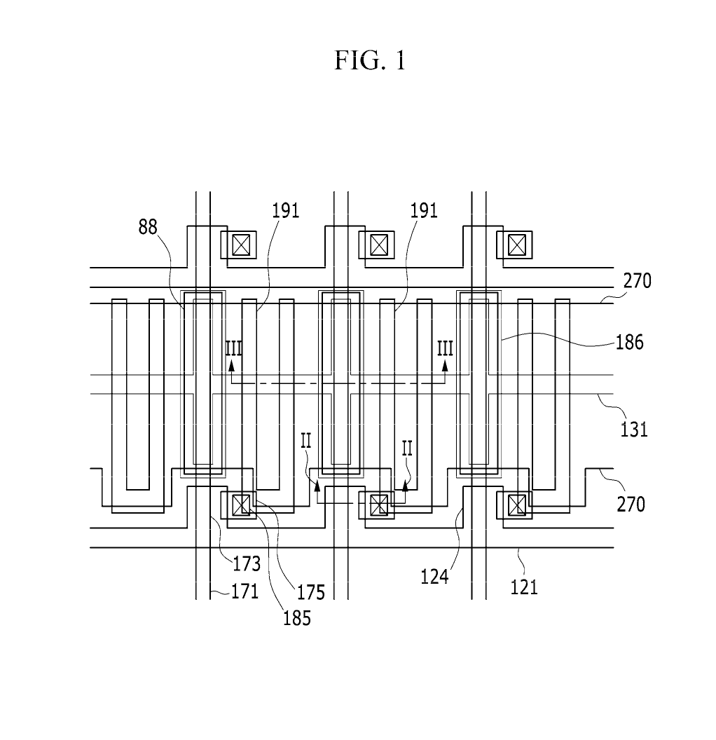

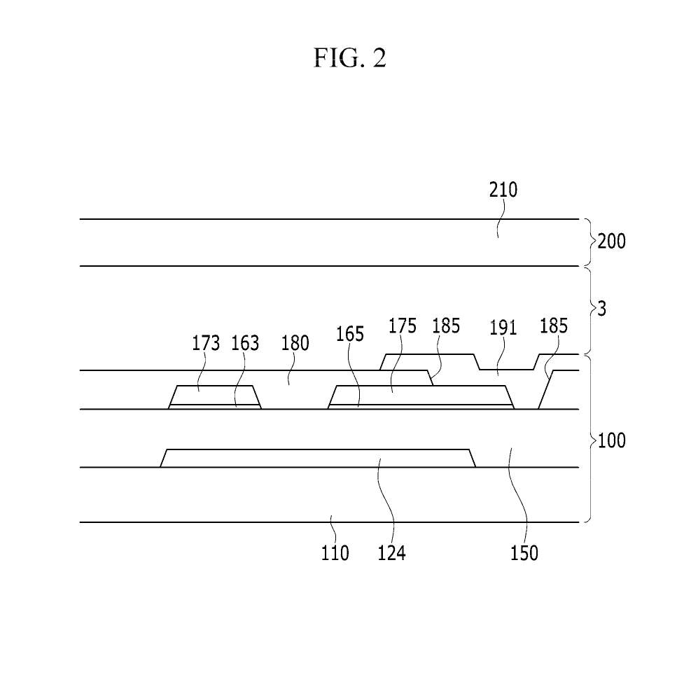

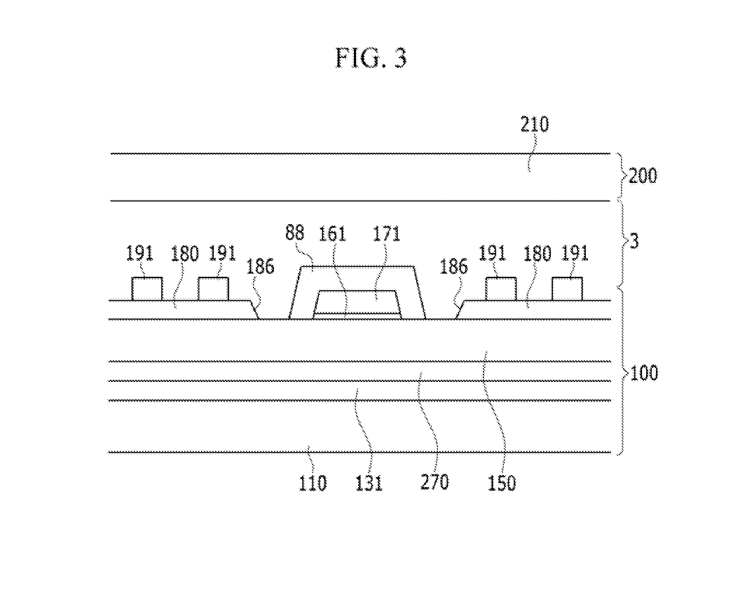

Hereinafter, a liquid crystal display according to an exemplary embodiment will be described with reference to FIG. 1 to FIG. 3. FIG. 1 is a layout view of a liquid crystal display according to an exemplary embodiment, FIG. 2 is a cross-sectional view of the liquid is crystal display shown in FIG. 1 taken along the line II-II, and FIG. 3 is a cross-sectional view of the liquid crystal display shown in FIG. 1 taken along the line III-III.

Referring to FIG. 1 to FIG. 3, the liquid crystal display according to the exemplary embodiment includes a first display panel 100 and a second display panel 200 disposed to face each other, and a liquid crystal layer 3 injected between the first display panel 100 and the second display panel 200.

First, the first display panel 100 will be described.

A plurality of gate lines 121 and common voltage lines 131 are formed on a first substrate 110.

Each of the gate lines 121 includes a plurality of gate electrodes 124.

The common voltage lines 131 are connected to a plurality of pixel areas to apply common voltages to a plurality of common electrodes disposed in the pixels.

A common electrode 270 is formed on the common voltage lines 131. The common electrode 270 is disposed between two adjacent gate lines 121, and is formed immediately on the common voltage line 131.

A semiconductor layer 150 is formed on the common electrodes 270 and the gate lines 121. The semiconductor layer 150 is formed on an entire surface of the first substrate 110.

Ohmic contacts 161, 163 and 165 are formed on the semiconductor layer 150, and a data line 171, a source electrode 173, and a drain electrode 175 are formed on the ohmic contacts 161, 163 and 165.

The data line 171 serves to transfer a data signal and mainly extends in a vertical direction to cross the gate line 121.

The source electrode 173 is a part of the data line 171, and is disposed on the same line as the data line 171. The drain electrode 175 is formed to extend in parallel with the source electrode 173. Accordingly, the drain electrode 175 is parallel with the part of the data line 171.

The liquid crystal display according to the exemplary embodiment includes the source electrode 173 disposed on the same line as the data line 171 and the drain electrode 175 extending in parallel with the data line 171, and as a result, a width of the thin film transistor may be increased while an area occupied by the data conductor is not increased, thereby increasing an aperture ratio of the liquid crystal display.

A passivation layer 180 is formed on the semiconductor layer 150, the data line 171, the source electrode 173, and the drain electrode 175.

A first contact hole 185 for partially exposing the drain electrode 175 and a first cutout 186 for partially exposing the data line 171 are formed in the passivation layer 180.

A shielding electrode 88 and a pixel electrode 191 are formed on the passivation layer 180.

The pixel electrode 191 is connected to the drain electrode 175 through the first contact hole 185, and the shielding electrode 88 serves to cover top and side surfaces of the data line that is exposed through the first cutout 186.

A first alignment layer (not shown) is coated on an inner surface of the first display panel 100.

Next, the second display panel 200 will be described. The second display panel 200 includes a second substrate 210. A second alignment layer (not shown) is coated on an inner surface of the second substrate 210.

Each of the first alignment layer and the second alignment layer may be a horizontal alignment layer.

The liquid crystal layer 3 interposed between the first display panel 100 and the second display panel 200 includes liquid crystal molecules (not shown), and the liquid crystal molecules may be aligned such that long axes thereof are horizontal with respect to the surfaces of the two display panels 100 and 200 in a state where no electric field is generated.

A backlight unit (not shown) may be further disposed outside the first substrate 110 to generate light and supply the generated light to the display panels 100 and 200.

The common electrode 270 is formed to have a planar shape, and the pixel electrode 191 includes a plurality of branch electrodes. The branch electrodes of the pixel electrode 191 are overlapped with the planar-shaped common electrode 270.

The pixel electrode 191 to which a data voltage is applied generates an electric field in the liquid crystal layer 3 together with the common electrode 270 to which a common voltage is applied to determine the orientation of the liquid crystal molecules of the liquid crystal layer 3, thereby displaying corresponding images.

In the liquid crystal display according to the exemplary embodiment, the planar-shaped common electrode is formed immediately on the common voltage line, and a semiconductor layer is formed on the common electrode and the gate line, serving as a gate insulating layer. Accordingly, it is possible to prevent signal delay of the common voltage and an increase in the manufacturing cost by forming a common electrode and a pixel electrode on one substrate and forming a common electrode immediately on a common voltage line.

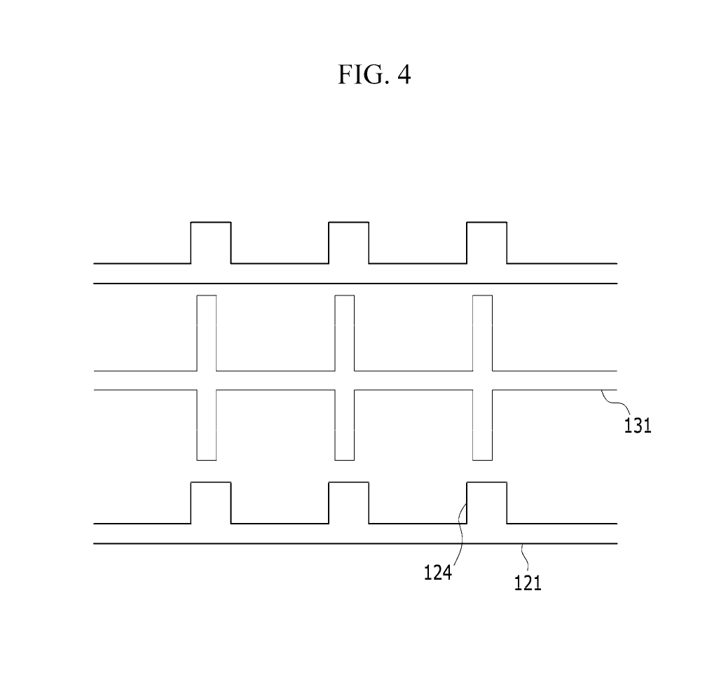

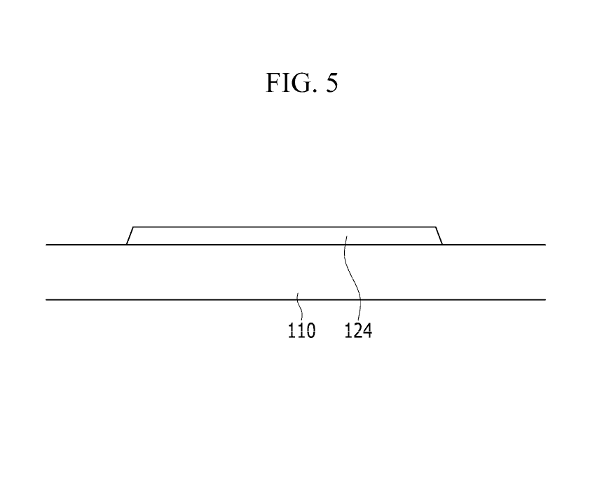

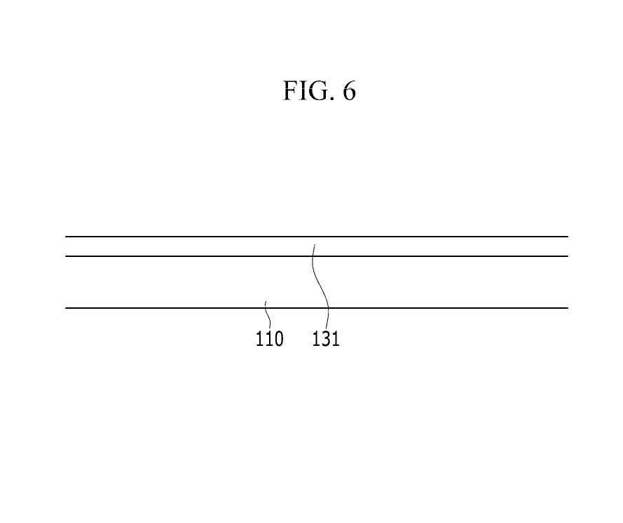

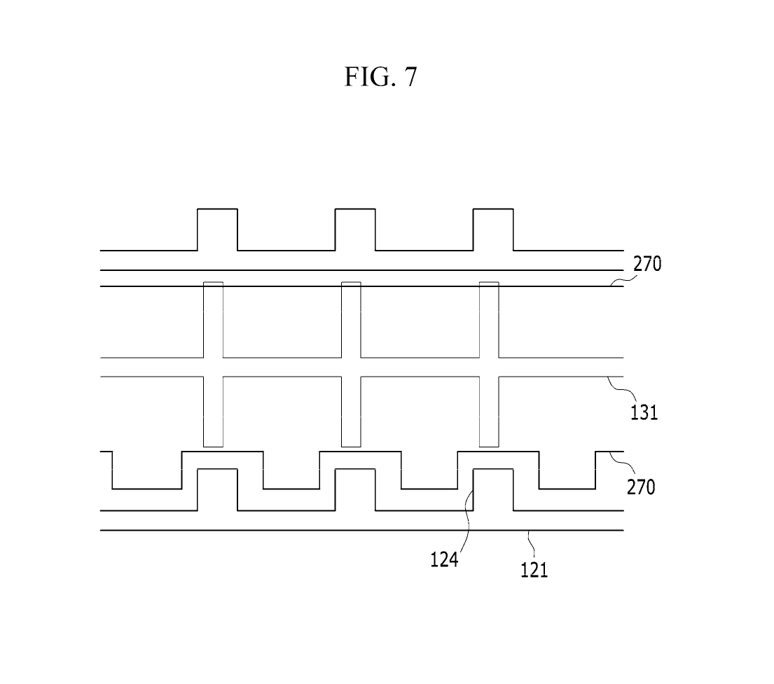

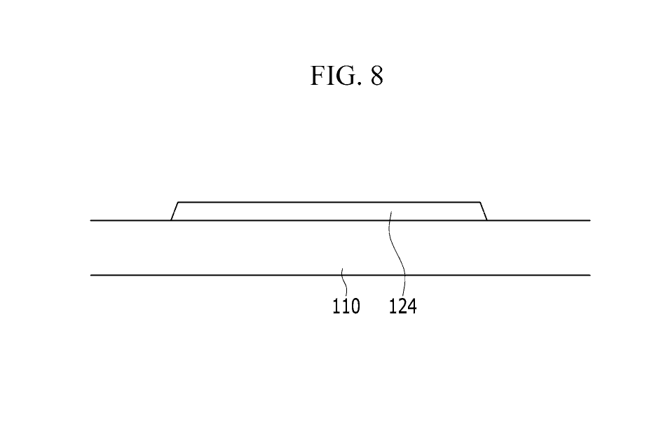

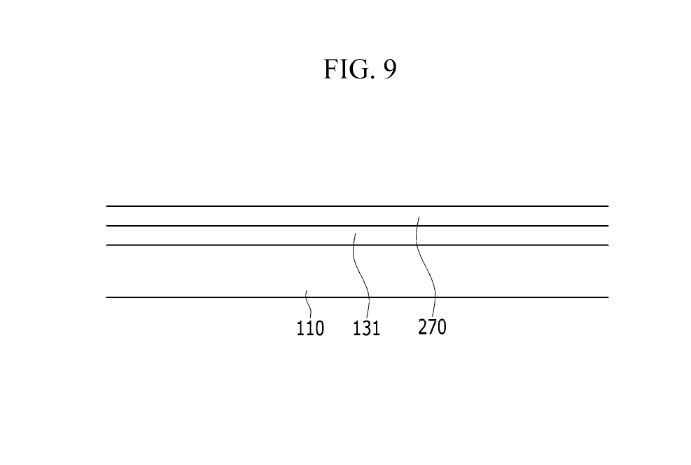

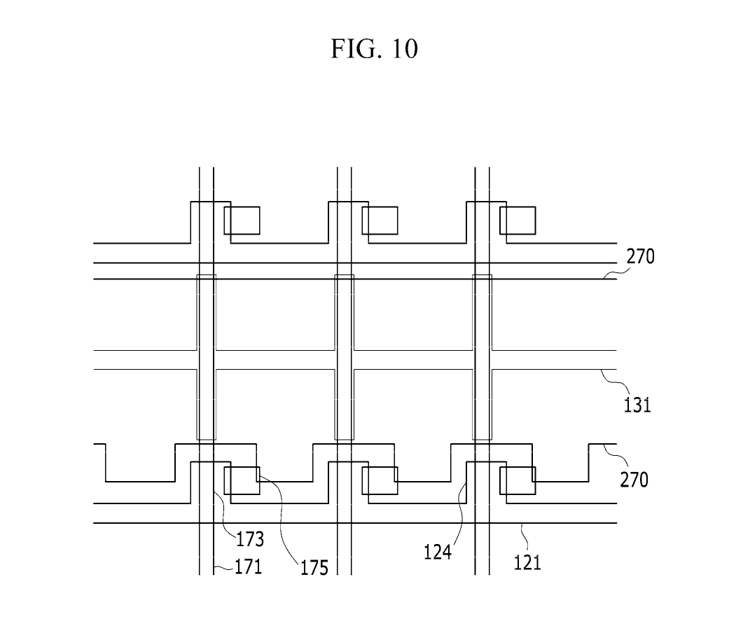

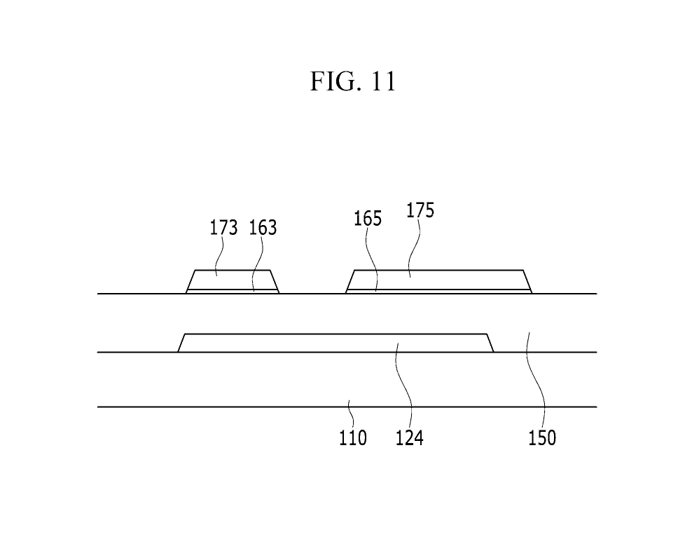

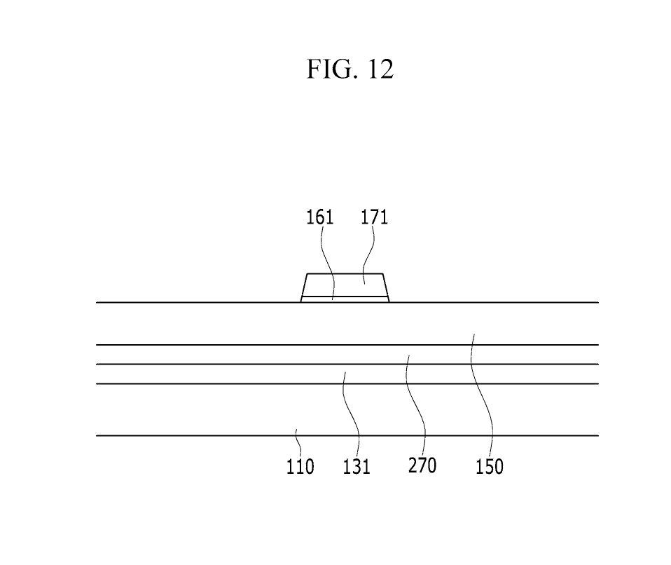

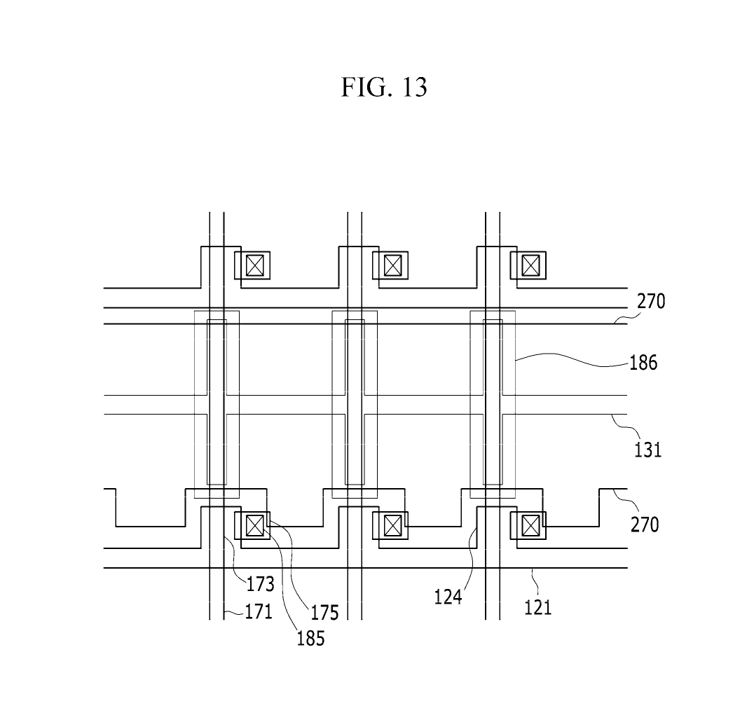

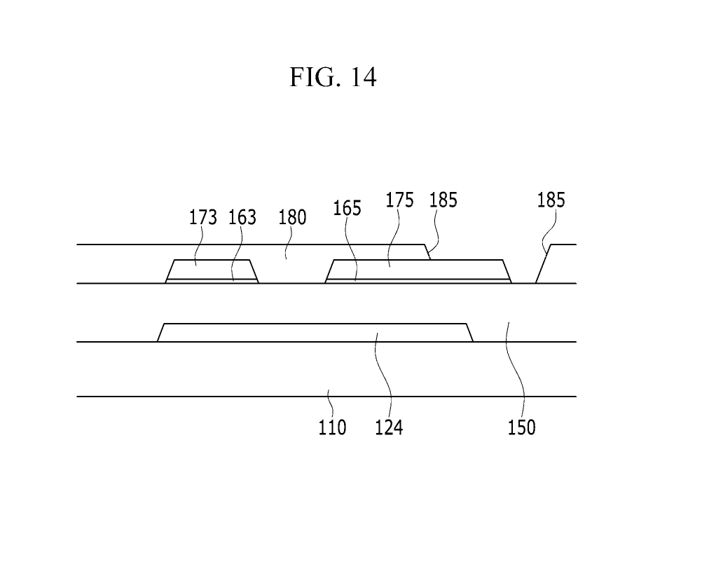

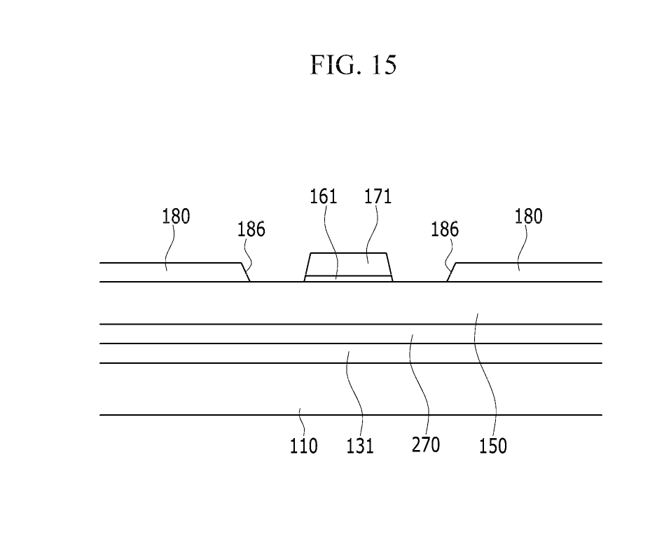

Hereinafter, a manufacturing method of a liquid crystal display according to an exemplary embodiment will be described with reference to FIG. 4 to FIG. 15 as well as FIG. 1 to FIG. 3. FIG. 4, FIG. 7, FIG. 10, and FIG. 13 are layout views sequentially illustrating a manufacturing method of a liquid crystal display according to an exemplary embodiment. FIG. 5, FIG. 8, FIG. 11, and FIG. 14 are cross-sectional views sequentially illustrating a manufacturing method of a liquid crystal display according to an exemplary embodiment, which are taken along the line II-II of FIG. 1. FIG. 6, FIG. 9, FIG. 12, and FIG. 15 are cross-sectional views sequentially illustrating a manufacturing method of a liquid crystal display according to an exemplary embodiment, which are taken along the line III-III of FIG. 1.

As shown in FIG. 4 to FIG. 6, the gate lines 121 and the common voltage lines 131 are formed on the first substrate 110. The gate lines 121 and the common voltage lines 131 are formed together by using the same material.

Referring to FIG. 7 to FIG. 9, the common electrode 270 is formed immediately on the common voltage lines 131. The common electrode 270 is formed to be disposed between two adjacent gate lines 121.

As shown in FIG. 10 to FIG. 12, the semiconductor layer 150 is formed on the common electrodes 270 and the gate lines 121, the ohmic contacts 161, 163 and 165 are formed on the semiconductor layer 150, and the data line 171, the source electrode 173, and the drain electrode 175 are formed on the ohmic contacts 161, 163 and 165. The semiconductor layer 150 is formed on an entire surface of the first substrate 110. The ohmic contacts 161, 163 and 165 are formed on the semiconductor layer 150 and between the data line 171, the source electrode 173, and the drain electrode 175.

Next, as shown in FIG. 12 to FIG. 14, the passivation layer 180 is formed on semiconductor layer 150, the data line 171, the source electrode 173, and the drain electrode 175. In this case, the first contact hole 185 for partially exposing the drain electrode 175 and the first cutout 186 for partially exposing the data line 171 are formed in the passivation layer 180.

Next, as shown in FIG. 1 to FIG. 3, the first display panel 100 is formed by disposing the pixel electrode 191 which is connected to the drain electrode 175 through the first contact hole 185 and the shielding electrode 88 serving to cover top and side surfaces of the data line that is exposed through the first cutout 186.

The second display panel 200 is then formed, and the liquid crystal display is manufactured by disposing the first display panel 100 and the second display panel 200 to face each other such that the liquid crystal layer 3 is interposed between the first display panel 100 and the second display panel 200.

In accordance with the manufacturing method of the liquid crystal display according to the exemplary embodiment, the planar-shaped common electrode is formed directly on the common voltage line, and a semiconductor layer is formed on the common electrode and the gate line, serving as a gate insulating layer. Accordingly, it is possible to prevent signal delay of the common voltage and an increase in the manufacturing cost by forming a common electrode and a pixel electrode on one substrate and forming a common electrode directly on a common voltage line.

Although certain exemplary embodiments and implementations have been described herein, other embodiments and modifications will be apparent from this description. Accordingly, the inventive concept is not limited to such embodiments, but rather to the broader scope of the presented claims and various obvious modifications and equivalent arrangements.

What is claimed is:

1. A liquid crystal display comprising:
a substrate;
a gate line and a common voltage line disposed on the substrate;
a common electrode disposed directly on the common voltage line;
a semiconductor layer disposed on the gate line and the common electrode; and
a pixel electrode disposed on the semiconductor layer,
wherein the common electrode and the pixel electrode are configured to overlap with each other, with the semiconductor layer disposed therebetween.

2. The liquid crystal display of claim 1, wherein the semiconductor layer is disposed on an entire surface of the substrate.

3. The liquid crystal display of claim 2, further comprising:
a data line, a source electrode, and a drain electrode disposed on the semiconductor layer; and
a passivation layer disposed on the source electrode and the drain electrode.

4. The liquid crystal display of claim 3, wherein the passivation layer comprises a contact hole for partially exposing the drain electrode and a cutout for partially exposing the data line, and
the pixel electrode is connected to the drain electrode through the contact hole.

5. The liquid crystal display of claim 4, further comprising a shielding electrode configured to cover top and side surfaces of a part of the data line that is exposed through the cutout.

6. A manufacturing method of a liquid crystal display, the method comprising:
forming a gate line and a common voltage line on a substrate;
forming a common electrode directly on the common voltage line;
forming a semiconductor layer on the gate line and the common electrode; and
forming a pixel electrode on the semiconductor layer,
wherein the common electrode and the pixel electrode are formed to overlap each other, with the semiconductor layer therebetween.

7. The manufacturing method of claim 6, wherein the semiconductor layer is formed on an entire surface of the substrate.

8. The manufacturing method of claim 7, further comprising:
forming a data line, a source electrode, and a drain electrode on the semiconductor layer; and
forming a passivation layer on the source electrode and the drain electrode.

9. The manufacturing method of claim 8, wherein:
the forming of the passivation layer comprises forming a contact hole for partially exposing the drain electrode and a cutout for partially exposing the data line in the passivation layer; and
the forming of the pixel electrode comprises forming the pixel electrode to be connected to the drain electrode through the contact hole.

10. The manufacturing method of claim 8, further comprising forming a shielding electrode configured to cover top and side surfaces of a part of the data line that is exposed through the cutout.
